(19) United States
(12) Patent Application Publication
(10) Pub. No.: US 2026/0204930 A1
(43) Pub. Date: Jul. 16, 2026

(54) METHOD OF CONTROLLING STATE OF CHARGE OF BATTERY SYSTEM

(71) Applicant: Caterpillar Inc., Peoria, IL (US)

(72) Inventors: Stephen Edwards, Peterborough (GB); Alexander Charles Brown, Lincolnshire (GB)

(73) Assignee: Caterpillar Inc., Peoria, IL (US)

(21) Appl. No.: 19/023,574

(22) Filed: Jan. 16, 2025

(51) Int. Cl. H02J 7/00

(52) U.S. Cl. CPC H02J 7/61; H02J 7/82

(57) ABSTRACT

A method of controlling a state of charge (SOC) of a battery system includes defining a first SOC threshold greater than zero and a second SOC threshold lower than the battery system's highest charge capacity. The method includes determining a value of imbalance between two or more cells of the battery system. The method also includes determining a battery protection charge range based on the two SOC thresholds, and the value of imbalance between the two or more cells. The method includes setting a first battery protection charge threshold at or above the first SOC threshold. The method also includes setting a second battery protection charge threshold higher than the first SOC threshold but no greater than the second SOC threshold. A range between the first battery protection charge threshold and the second battery protection charge threshold is defined by the battery protection charge range.

### TECHNICAL FIELD

The present disclosure relates to a method of controlling a state of charge of a battery system and a controller for controlling the state of charge of the battery system of an electric work vehicle.

### BACKGROUND

Work machines like mining trucks, loaders, dozers, and other construction or mining equipment are increasingly being powered by battery systems (or battery packs). It is desirable to monitor a charge level of the battery systems, which is typically expressed as a percentage of a total charge capacity, ranging from 0% to 100%. This percentage is known as a state of charge (SOC) of the battery system.

To ensure optimal performance, it is recommended to maintain the SOC between 20% and 80%. Further, a usable SOC is unlikely to be equal to the total SOC due to a calibration of the battery system that prevents the work machine from accessing lower and upper portions (i.e., lower than 20% and above 80%) of the total SOC to prevent damage to the battery system. Therefore, the usable SOC is determined and displayed on a user interface. Typically, the usable SOC is defined based on a lowest or average cell SOC hitting the fully charged level, however, in some cases the battery system will be prevented from reaching fully charged level due to a highest cell hitting a maximum voltage limit first. Conventionally, a scaling technique is used to scale from the total SOC to the usable SOC.

EP3443636 describes a battery cell balancing system that includes a cell monitoring block designed to monitor the voltage or a related parameter across individual cells in a battery module. A microcontroller is responsible for monitoring both the positive terminal voltage and the negative terminal voltage of the battery module, as well as the output current and the individual cell voltages of the cells. The microcontroller generates a control signal based on these monitored values, including the positive and negative terminal voltages, output current, and individual cell voltages. A hybrid module balancing block is then responsible for providing active, passive, or a combination of both types of balancing for the cells in the module, all controlled by the signal from the microcontroller. The patent also includes a method for balancing battery cells in a battery that consists of one or more modules, each containing one or more cells.

### SUMMARY OF THE DISCLOSURE

In an aspect of the present disclosure, a method of controlling a state of charge (SOC) of a battery system is provided. The method includes defining a first SOC threshold of the battery system. The first SOC threshold is greater than zero. The method also includes defining a second SOC threshold of the battery system. The second SOC threshold is less than a highest charge capacity of the battery system. The method further includes determining a value of imbalance between two or more cells of the battery system. The method includes determining a battery protection charge range based on the first SOC threshold, the second SOC threshold, and the value of imbalance between the two or more cells. The method also includes setting a first battery protection charge threshold of the battery system. The first battery protection charge threshold is at least the first SOC threshold. The method further includes setting a second battery protection charge threshold of the battery system. The second battery protection charge threshold is no greater than the second SOC threshold and greater than the first SOC threshold. Further, a range between the first battery protection charge threshold and the second battery protection charge threshold is defined by the battery protection charge range.

In another aspect of the present disclosure, a controller for controlling a state of charge (SOC) of a battery system of an electric work vehicle is provided. The controller is configured to define a first SOC threshold of the battery system. The first SOC threshold is greater than zero. The controller is also configured to define a second SOC threshold of the battery system. The second SOC threshold is less than a highest charge capacity of the battery system. The controller is further configured to determine a value of imbalance between two or more cells of the battery system. The controller is configured to determine a battery protection charge range based on the first SOC threshold, the second SOC threshold, and the value of imbalance between the two or more cells. The controller is also configured to set a first battery protection charge threshold of the battery system. The first battery protection charge threshold is at least the first SOC threshold. The controller is further configured to set a second battery protection charge threshold of the battery system. The second battery protection charge threshold is no greater than the second SOC threshold and greater than the first SOC threshold. Further, a range between the first battery protection charge threshold and the second battery protection charge threshold is defined by the battery protection charge range.

Other features and aspects of this disclosure will be apparent from the following description and the accompanying drawings.

### BRIEF DESCRIPTION OF THE DRAWINGS

FIG. 1 is a schematic view of an electric work vehicle, according to an example of the present disclosure;

FIG. 2 is a block diagram of a battery system, and a controller communicably coupled with the battery system, according to an example of the present disclosure;

FIG. 3 is a graph of SOC values and time, according to an example of the present disclosure;

FIG. 4 is a schematic diagram of different SOC ranges, according to an example of the present disclosure and

FIG. 5 is a flowchart for a method of controlling a SOC of the battery system, according to an example of the present disclosure.

### DETAILED DESCRIPTION

Wherever possible, the same reference numbers will be used throughout the drawings to refer to the same or like parts.

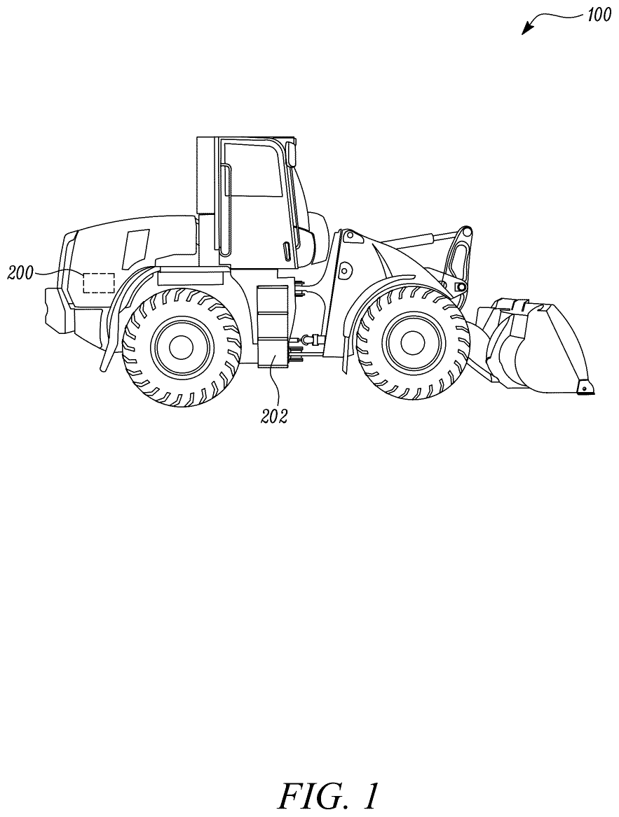

Referring to FIG. 1, a schematic view of an electric work vehicle 100 is shown. The electric work vehicle 100 is a wheel loader herein. The electric work vehicle 100 shown in FIG. 1 is an example, and the electric work vehicle 100 may be any other type of electric work vehicle. The electric work vehicle 100 includes a battery system 200. The battery system 200 is rechargeable and may be connected to a charging module (not shown) for charging. The battery system 200 is supported on a frame 202 of the electric work vehicle 100. The battery system 200 is housed within the electric work vehicle 100 and is typically used to store electrical power and distribute the stored electrical power at a desired power output and a desired voltage output. It should be noted that this disclosure is not limited to battery systems associated with electric work vehicles. The battery systems 200 described in the disclosure may also be used in any equipment, movable or stationery, that incorporates battery systems.

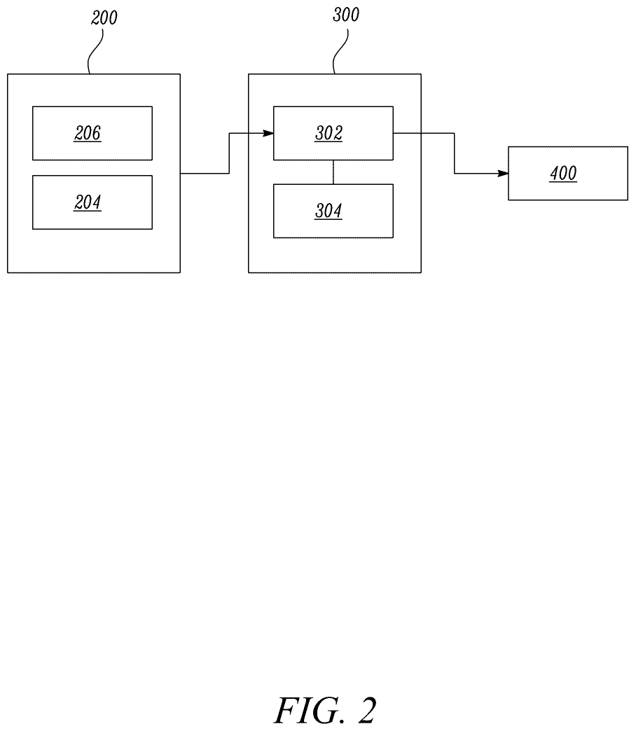

Referring to FIGS. 1 and 2, the electric work vehicle 100 includes a controller 300 for controlling a state of charge (SOC) of the battery system 200. As such, the controller 300 may control various operations related to the battery system 200, such as, a charging and/or a discharging of the battery system 200. The controller 300 may also be referred to as “a battery management system”. The controller 300 is communicably coupled with the battery system 200. Further, the controller 300 may be supported within the electric work vehicle 100.

Referring to FIG. 2, a block diagram of the battery system 200, and the controller 300 is shown. The battery system 200 includes two or more cells 204, 206. For illustrative purposes, the battery system 200 is shown to have two cells 204, 206 in FIG. 2. However, the battery system 200 may include any number of cells, similar to the cells 204, 206, that may be arranged in series, in parallel, or in a combination of parallel and series, without limiting the scope of the present disclosure. In this disclosure, the cell 204 is interchangeably referred to as “lowest capacity cell 204” and the cell 206 is interchangeably referred to as “highest capacity cell 206”. The cells 204, 206 forming the battery system 200 may incorporate, for example, a lithium-ion battery system. In other examples, the battery system 200 may embody any other type of battery technology/cell chemistry, such as, a lead-acid battery technology, nickel metal hydride battery technology, and the like that converts chemical energy directly to electrical energy by utilizing a difference in bond energies of the compounds utilized in the construction of the battery system 200.

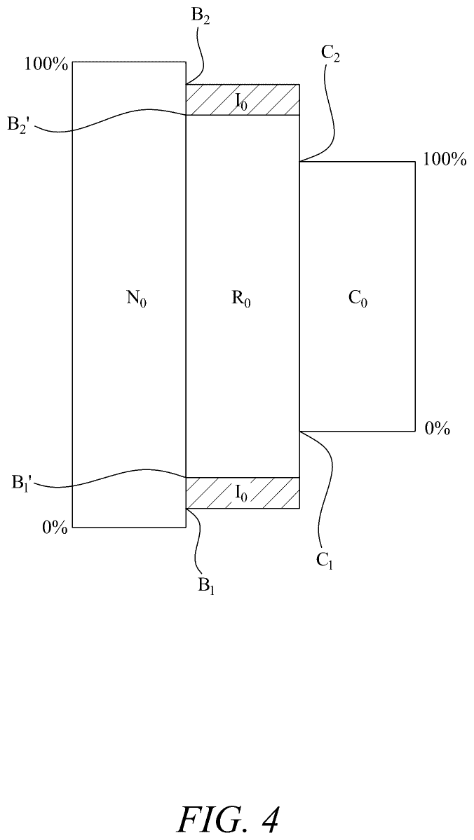

The battery system 200 has a battery capacity N₀ (shown in FIG. 4), which ranges from 0% SOC (i.e. fully discharged) to 100% SOC (i.e. fully charged). It will be appreciated that the SOC of the battery system 200 cannot drop below 0% SOC and cannot exceed 100% SOC. However, during actual use, the available capacity of the battery system 200 is lesser than the battery capacity N₀. The controller 300 carries out various calculations to determine a usable SOC of the battery system 200.

The controller 300 may be communicably coupled with the battery system 200 in a wired or wireless manner. The wireless connection may include, for example, Wi-Fi. The controller 300 includes one or more processors 302 and one or more memories 304 communicably coupled with the one or more processors 302. The one or more processors 302 may be any kind of hardware-based electronic device with data processing capabilities including, by way of non-limiting example a digital processing device, such as, digital signal processor (DSP), a microcontroller, a field programmable circuit, an application-specific integrated circuit (ASIC), etc., or any device which includes or is operatively connected to one or more processing devices, or an analog circuit implementing control logic. The one or more memories 304 may be any volatile or non-volatile computer memory.

Further, a user device 400 is communicably coupled with the controller 300. The user device 400 may be in communication with the controller 300 in a wired or wireless manner. The wireless connection may include, for example, Wi-Fi. The user device 400 is used for displaying the SOC of the battery system 200 thereon. Specifically, the user device 400 may display the usable SOC of the battery system 200 to a user. In an example, the user device 400 may be a display device and may be provided in a cabin of the electric work vehicle 100. The user device 400 may include a phone, a tablet, a laptop, and the like. In an example, the user device 400 may display a numerical indication of the usable SOC, or the user device 400 may display a graphical representation of the usable SOC. In either example, the user device 400 may indicate the usable SOC of the battery system 200 based on inputs provided by the controller 300.

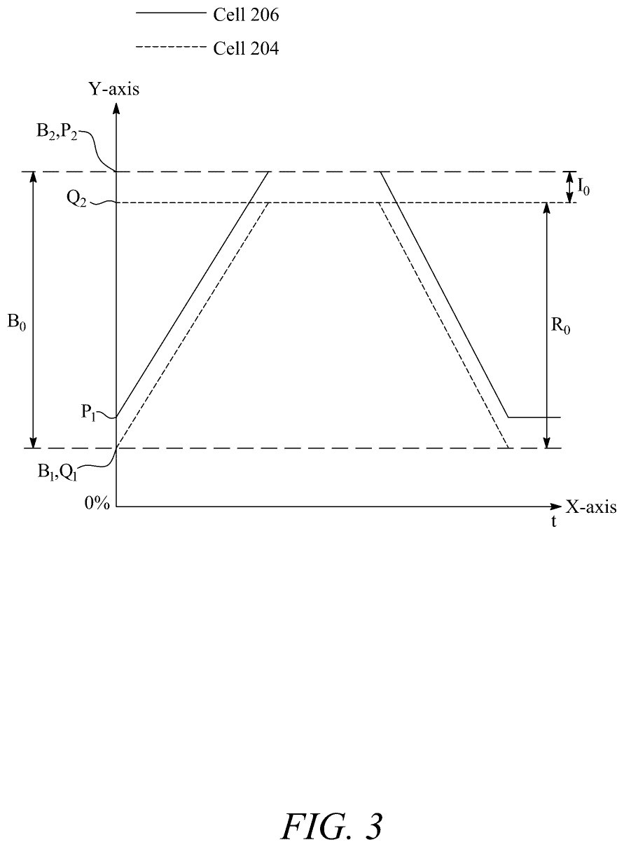

Referring to FIG. 3, a graph of SOC values and time t is provided. The graph was created by plotting various values of time t on X-axis and various SOC values on Y-axis during charging and discharging of the battery system 200 (see FIG. 2).

The cell 206 (see FIG. 2) is the highest capacity cell 206, such that during charging, the cell 206 reaches a maximum SOC P₂ and during discharging, the cell 206 reaches a minimum SOC P₁. The maximum SOC P₂ is interchangeably written in the present disclosure as “the maximum SOC P₂ of the highest capacity cell 206”. The minimum SOC P₁ is interchangeably written in the present disclosure as “the minimum SOC P₁ of the highest capacity cell 206”.

Further, the cell 204 (see FIG. 2) is the lowest capacity cell 204, such that during charging, the cell 204 reaches a maximum SOC Q₂, and during discharging, the cell 204 reaches a minimum SOC Q₁. The maximum SOC Q₂ is interchangeably written in the present disclosure as “the maximum SOC Q₂ of the lowest capacity cell 204”. Further, the minimum SOC Q₁ is interchangeably written in the present disclosure as “the minimum SOC Q₁ of the lowest capacity cell 204”.

Referring to FIGS. 2 and 4, the controller 300 defines a first SOC threshold B₁ of the battery system 200. The first SOC threshold B₁ is greater than zero. The first SOC threshold B₁ corresponds to the minimum SOC Q₁ of the lowest capacity cell 204 of the battery system 200. In an example, the first SOC threshold B₁ may be greater than or equal to 5% of a highest charge capacity of the battery system 200. In another example, the first SOC threshold B₁ may be greater than or equal to 7%, 10%, or 15% of the highest charge capacity of the battery system 200.

Further, the controller 300 defines a second SOC threshold B₂ of the battery system 200. The second SOC threshold B₂ is less than the highest charge capacity (i.e., 100% SOC) of the battery system 200. The second SOC threshold B₂ corresponds to the maximum SOC P₂ of the highest capacity cell 206 of the battery system 200. In an example, the second SOC threshold B₂ may be no greater than 95% of the highest charge capacity of the battery system 200. In another example, the second SOC threshold B₂ may be no greater than 92%, 90%, or 85% of the highest charge capacity of the battery system 200. As the first and second SOC thresholds B₁, B₂ are intended to represent SOC thresholds of the battery system 200, the first and second SOC thresholds B₁, B₂ may each be represented by a value between 0 and 1.

Further, the controller 300 determines a SOC threshold value B₀ based on a difference between the second SOC threshold B₂ and the first SOC threshold B₁. The following equation may be used to determine the value of the SOC threshold value B₀: B₀=B₂−B₁.

The SOC threshold value B₀ and the first and second SOC thresholds B B₂ may be stored in the memories 304 associated with the controller 300. The SOC threshold value B₀ and the first and second SOC thresholds B₁, B₂ may be set based on the characteristics of the battery system 200 and desired operating characteristics of the battery system 200. In general, increasing the SOC threshold value B₀ increases the available capacity of the battery system 200. Decreasing the SOC threshold value B₀ may reduce the extent to which the battery system 200 is charged to a high level of charge (i.e. towards 100% SOC) or discharged to a low level of charge (i.e. towards 0% SOC), which in turn improves battery lifetime.

Further, the controller 300 determines a value of imbalance I₀ between the two or more cells 204, 206 based on a difference between the maximum SOC P₂ of the highest capacity cell 206 from the two or more cells 204, 206 and the maximum SOC Q₂ of the lowest capacity cell 204 from the two or more cells 204, 206. The following equation may be used to determine the value of imbalance I₀: I₀=P₂−Q₂.

Further, the controller 300 determines a battery protection charge range R₀ based on a difference between the SOC threshold value B₀ and the value of imbalance I₀ between the two or more cells 204, 206. The following equation may be used to determine the value of the battery protection charge range R₀: R₀=B₀−I₀.

Further, the controller 300 sets a first battery protection charge threshold B₁′ of the battery system 200. The first battery protection charge threshold B₁′ is greater than or equal to the first SOC threshold B₁. The first battery protection charge threshold B₁′ is calculated based on the first SOC threshold B₁, a trim parameter T, the battery protection charge range R₀, and the SOC threshold value B₀. The trim parameter T is a value between 0 and 1. Details of the trim parameter T are provided later in this section.

Further, the controller 300 sets a second battery protection charge threshold B₂′ of the battery system 200. The second battery protection charge threshold B₂′ is no greater than the second SOC threshold B₂ and greater than the first SOC threshold B₁. The second battery protection charge threshold B₂′ is calculated based on the second SOC threshold B₂, the trim parameter T, the battery protection charge range R₀, and the SOC threshold value B₀. A range between the first battery protection charge threshold B₁′ and the second battery protection charge threshold B₂′ is defined by the battery protection charge range R₀. The following equation may be used to establish the relationship between the first battery protection charge threshold B₁′, the second battery protection charge threshold B₂′ and the battery protection charge range R₀: R₀=B₂′−B₁′.

As such, the battery protection charge range R₀ may define a range of the SOC that is available for use. For example, the battery protection charge range R₀ may be about: 80, 85, or 90% of the battery capacity N₀ of the battery system 200.

Further, the controller 300 updates each of the battery protection charge range R₀, the first battery protection charge threshold B₁′, and the second battery protection charge threshold B₂′ based on an update to the value of imbalance I₀ between the two or more cells 204, 206. The controller 300 may receive SOC values of the cells 204, 206 at regular time intervals to determine the value of imbalance I₀. Further, the controller 300 also updates the first battery protection charge threshold B₁′ and the second battery protection charge threshold B₂′ based on an update to the trim parameter T associated with the battery system 200.

The controller 300 further sets a first configurable SOC threshold C₁ of the battery system 200. The first configurable SOC threshold C₁ is greater than or equal to the first battery protection charge threshold B₁′. Further, the controller 300 sets a second configurable SOC threshold C₂ of the battery system 200. The second configurable SOC threshold C₂ is no greater than the second battery protection charge threshold B₂′ and greater than the first battery protection charge threshold B₁′. The following equation may be used to establish the relationship between the first configurable SOC threshold C₁, the second configurable SOC threshold C₂, the first battery protection charge threshold B₁′, and the second battery protection charge threshold B₂′: C₂−C₁<=B₂′−B₁′.

Further, a range between the first configurable SOC threshold C₁ and the second configurable SOC threshold C₂ is defined by a configurable capacity C₀ associated with the battery system 200. During charging and/or discharging of the battery system 200, the usable SOC of the battery system 200 is controlled based on the first configurable SOC threshold C₁ and the second configurable SOC threshold C₂.

As the first and second configurable SOC thresholds C₁, C₂ are intended to represent SOC thresholds of the battery system 200, the first and second configurable SOC thresholds C₁, C₂ may each be represented by a value between 0 and 1. The configurable capacity C₀ may also be expressed in terms of a percentage of the battery capacity N₀ (i.e. a value between 0 and 1)

The following equation may be used to establish the relationship between the configurable capacity C₀, the battery capacity N₀, the first configurable SOC threshold C₁, and the second configurable SOC threshold C₂: C₂−C₁=C₀/ N₀.

The first configurable SOC threshold C₁ is calculated based on the first battery protection charge threshold B₁′, the trim parameter T, the configurable capacity C₀, and the battery protection charge range R₀. Further, the second configurable SOC threshold C₂ is calculated based on the second battery protection charge threshold B₂′, the trim parameter T, the configurable capacity C₀, and the battery protection charge range R₀. The trim parameter T is a value between 0 and 1 which skews the configurable capacity C₀ to the lower or higher end of the battery capacity N₀. In an example, the trim parameter T may be used to specify a position of the configurable capacity C₀ within the battery protection charge range R₀. As such, the trim parameter T may define the positions of the first and second configurable SOC thresholds C₁, C₂ relative to the positions of the first and second battery protection charge thresholds B₁′, B₂′. The trim parameter T may be used to determine the first and second configurable SOC thresholds C₁, C₂ based on the configurable capacity C₀. It will be appreciated that the trim parameter T may be used to shift the relative position of the configurable capacity C₀ within the battery protection charge range R₀. For example, when T=1, the second configurable SOC threshold C₂ will be positioned such that it is equal to the second battery protection charge threshold B₂′. When T=0, the first configurable SOC threshold C₁ will be positioned such that it is equal to the second battery protection charge threshold B₂′. In some examples, where no trim parameter T is provided, or not updated, the trim parameter T may take a default value. For example, a default value may be T=0.5 in order to balance the configurable capacity C₀ at a center of the battery protection charge range R₀.

Further, the controller 300 updates the first configurable SOC threshold C₁ and the second configurable SOC threshold C₂ based on the trim parameter T associated with the battery system 200. For example, the trim parameter T may be increased to shift the configurable capacity C₀ towards a higher SOC level in order to improve power output. Alternatively, the trim parameter T may be decreased to shift the configurable capacity C₀ towards a lower SOC level in order to improve battery lifetime.

In some examples, the SOC indicated on the user device 400 may correspond to the charge remaining within the configurable capacity C₀, rather than usable SOC of the battery system 200. In such a case, the controller 300 may output a mapped SOC value to the user device 400, rather than a value representative of the usable SOC of the battery system 200.

In order to output the mapped SOC value, the controller 300 may map the first configurable SOC threshold C₁ to a value indicative of 0% SOC of a usable SOC range and the second configurable SOC threshold C₂ may be mapped to a value indicative of 100% SOC of the usable SOC range.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure is related to the controller 300 for controlling the SOC of the battery system 200 of the electric work vehicle 100. The controller 300 defines the first SOC threshold B₁ and the second SOC threshold B₂ of the battery system 200. The controller 300 also determines the value of imbalance I₀ between the two or more cells 204, 206 of the battery system 200. The controller 300 further determines the battery protection charge range R₀ based on the first SOC threshold B₁, the second SOC threshold B₂, and the value of imbalance I₀ between the two or more cells 204, 206. The controller 300 further sets the first battery protection charge threshold B₁′ and the second battery protection charge threshold B₂′ of the battery system 200. The range between the first battery protection charge threshold B₁′ and the second battery protection charge threshold B₂′ is defined by the battery protection charge range R₀.

The controller 300 considers the SOC imbalance between the cells 204, 206 within the battery system 200 when calculating the scaling from the battery capacity N₀ to the configurable capacity C₀. Thus, the controller 300 may provide an accurate and detailed configurable capacity C₀ for the user. The controller 300 may provide improved clarity to the user on the usable SOC displayed on the user device 400. The controller 300 may provide better utilization of the battery capacity N₀ without battery degradation. The controller 300 may provide improved control of current limits towards extremes of the usable SOC range. The proposed solution adjusts the calculation of the usable SOC range, such that a full range of 0-100% SOC can always be reached.

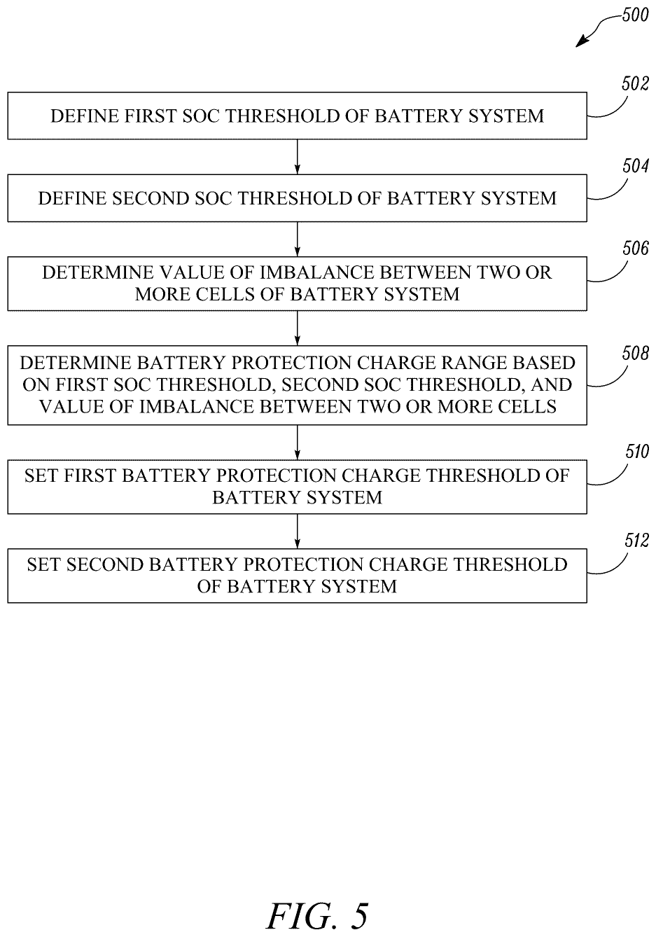

FIG. 5 is a flowchart for a method 500 of controlling the SOC of the battery system 200. The battery system 200 is provided as a part of the electric work vehicle 100. With reference to FIGS. 1 to 5 at a step 502, the first SOC threshold B₁ of the battery system 200 is defined. The first SOC threshold B₁ is greater than zero. The first SOC threshold B₁ is greater than or equal to 5% of the highest charge capacity of the battery system 200. The first SOC threshold B₁ corresponds to the minimum SOC Q₁ of the lowest capacity cell 204. At a step 504, the second SOC threshold B₂ of the battery system 200 is defined. The second SOC threshold B₂ is less than the highest charge capacity of the battery system 200. The second SOC threshold B₂ corresponds to the maximum SOC P₂ of the highest capacity cell 206. The second SOC threshold B₂ is no greater than 95% of the highest charge capacity of the battery system 200.

At a step 506, the value of imbalance I₀ between the two or more cells 204, 206 of the battery system 200 is determined. At a step 508, the battery protection charge range R₀ is determined based on the first SOC threshold B₁, the second SOC threshold B₂, and the value of imbalance I₀ between the two or more cells 204, 206. At a step 510, the first battery protection charge threshold B₁′ of the battery system 200 is set. The first battery protection charge threshold B₁′ is greater than or equal to the first SOC threshold B₁. At a step 512, the second battery protection charge threshold B₂′ of the battery system 200 is set. The second battery protection charge threshold B₂′ is no greater than the second SOC threshold B₂ and greater than the first SOC threshold B₁. Further, the range between the first battery protection charge threshold B₁ ′ and the second battery protection charge threshold B₂′ is defined by the battery protection charge range R₀.

In one example, the method 500 further includes a step (not shown) at which the SOC threshold value B₀ is determined based on the difference between the second SOC threshold B₂ and the first SOC threshold B₁.

In another example, the method 500 further includes a step (not shown) at which the value of imbalance I₀ between the two or more cells 204, 206 is determined based on the difference between the maximum SOC P₂ of the highest capacity cell 206 from the two or more cells 204, 206 and the maximum SOC Q₂ of the lowest capacity cell 204 from the two or more cells 204, 206.

The method 500 further includes a step (not shown) at which the battery protection charge range R₀ is determined based on the difference between the SOC threshold value B₀ and the value of imbalance I₀ between the two or more cells 204, 206.

The method 500 further includes a step (not shown) at which each of the battery protection charge range R₀, the first battery protection charge threshold B₁′, and the second battery protection charge threshold B₂′ are updated based on the update to the value of imbalance I₀ between the two or more cells 204, 206.

The method 500 further includes a step (not shown) at which the first battery protection charge threshold B₁′ and the second battery protection charge threshold B₂′ are updated based on the trim parameter T associated with the battery system 200.

The method 500 further includes a step (not shown) at which the first configurable SOC threshold C₁ of the battery system 200 is set. The first configurable SOC threshold C₁ is greater than or equal to the first battery protection charge threshold B₁′. The method 500 further includes a step (not shown) at which the second configurable SOC threshold C₂ of the battery system 200 is set. The second configurable SOC threshold C₂ is no greater than the second battery protection charge threshold B₂′ and greater than the first battery protection charge threshold B₁′. Further, the range between the first configurable SOC threshold C₁ and the second configurable SOC threshold C₂ is defined by the configurable capacity C₀ associated with the battery system 200. Furthermore, during the charging and/or the discharging of the battery system 200, the SOC of the battery system 200 is controlled based on the first configurable SOC threshold C₁ and the second configurable SOC threshold C₂.

The method 500 further includes a step (not shown) at which the first configurable SOC threshold C₁ and the second configurable SOC threshold C₂ are updated based on the trim parameter T associated with the battery system 200.

It should be noted that the steps 502, 504, 506, 508, 510, 512 of the method 500 may be performed in a sequence that is different from that explained in relation to FIG. 5. Further, various steps 502, 504, 506, 508, 510, 512 can be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A method of controlling a state of charge (SOC) of a battery system, the method comprising:
defining a first SOC threshold of the battery system, the first SOC threshold being greater than zero;
defining a second SOC threshold of the battery system, the second SOC threshold being less than a highest charge capacity of the battery system;
determining a value of imbalance between two or more cells of the battery system;
determining a battery protection charge range based on the first SOC threshold, the second SOC threshold, and the value of imbalance between the two or more cells;
setting a first battery protection charge threshold of the battery system, the first battery protection charge threshold being at least the first SOC threshold; and
setting a second battery protection charge threshold of the battery system, the second battery protection charge threshold being no greater than the second SOC threshold and greater than the first SOC threshold, wherein a range between the first battery protection charge threshold and the second battery protection charge threshold is defined by the battery protection charge range.

2. The method of claim 1 further comprising:
determining a SOC threshold value based on a difference between the second SOC threshold and the first SOC threshold.

3. The method of claim 2 further comprising:
determining the battery protection charge range based on a difference between the SOC threshold value and the value of imbalance between the two or more cells.

4. The method of claim 1 further comprising:
determining the value of imbalance between the two or more cells based on a difference between a maximum SOC of a highest capacity cell from the two or more cells and a maximum SOC of a lowest capacity cell from the two or more cells.

5. The method of claim 4, wherein the first SOC threshold corresponds to a minimum SOC of the lowest capacity cell and the second SOC threshold corresponds to the maximum SOC of the highest capacity cell.

6. The method of claim 1 further comprising:
updating each of the battery protection charge range, the first battery protection charge threshold, and the second battery protection charge threshold based on an update to the value of imbalance between the two or more cells.

7. A method of claim 1 further comprising:
updating the first battery protection charge threshold and the second battery protection charge threshold based on a trim parameter associated with the battery system.

8. The method of claim 1 further comprising:
setting a first configurable SOC threshold of the battery system, the first configurable SOC threshold being at least the first battery protection charge threshold; and
setting a second configurable SOC threshold of the battery system, the second configurable SOC threshold being no greater than the second battery protection charge threshold and greater than the first battery protection charge threshold, wherein a range between the first configurable SOC threshold and the second configurable SOC threshold is defined by a configurable capacity associated with the battery system, and wherein, during charging and/or discharging of the battery system, the SOC of the battery system is controlled based on the first configurable SOC threshold and the second configurable SOC threshold.

9. A method of claim 8 further comprising:
updating the first configurable SOC threshold and the second configurable SOC threshold based on a trim parameter associated with the battery system.

10. The method of claim 1, wherein the battery system is provided as a part of an electric work vehicle.

11. The method of claim 1, wherein:
the first SOC threshold is at least 5% of the highest charge capacity of the battery system; and/or
the second SOC threshold is no greater than 95% of the highest charge capacity of the battery system.

12. A controller for controlling a state of charge (SOC) of a battery system of an electric work vehicle, the controller being configured to:
define a first SOC threshold of the battery system, the first SOC threshold being greater than zero;
define a second SOC threshold of the battery system, the second SOC threshold being less than a highest charge capacity of the battery system;
determine a value of imbalance between two or more cells of the battery system;
determine a battery protection charge range based on the first SOC threshold, the second SOC threshold, and the value of imbalance between the two or more cells;
set a first battery protection charge threshold of the battery system, the first battery protection charge threshold being at least the first SOC threshold; and
set a second battery protection charge threshold of the battery system, the second battery protection charge threshold being no greater than the second SOC threshold and greater than the first SOC threshold, wherein a range between the first battery protection charge threshold and the second battery protection charge threshold is defined by the battery protection charge range.

13. The controller of claim 12 further configured to:
determine a SOC threshold value based on a difference between the first SOC threshold and the second SOC threshold.

14. The controller of claim 13 further configured to:
determine the battery protection charge range based on a difference between the SOC threshold value and the value of imbalance between the two or more cells.

15. The controller of claim 12 further configured to:
determine the value of imbalance between the two or more cells based on a difference between a maximum SOC of a highest capacity cell from the two or more cells and a maximum SOC of a lowest capacity cell from the two or more cells.

16. The controller of claim 15, wherein the first SOC threshold corresponds to a minimum SOC of the lowest capacity cell and the second SOC threshold corresponds to the maximum SOC of the highest capacity cell.

17. The controller of claim 12 further configured to:
update each of the battery protection charge range, the first battery protection charge threshold, and the second battery protection charge threshold based on an update to the value of imbalance between the two or more cells.

18. A controller of claim 12 further configured to:
update the first battery protection charge threshold and the second battery protection charge threshold based on a trim parameter associated with the battery system.

19. The controller of claim 12 further configured to:
set a first configurable SOC threshold of the battery system, the first configurable SOC threshold being at least the first battery protection charge threshold; and
set a second configurable SOC threshold of the battery system, the second configurable SOC threshold being no greater than the second battery protection charge threshold and greater than the first battery protection charge threshold, wherein a range between the first configurable SOC threshold and the second configurable SOC threshold is defined by a configurable capacity associated with the battery system, and wherein, during charging and/or discharging of the battery system, the SOC of the battery system is controlled based on the first configurable SOC threshold and the second configurable SOC threshold.

20. A controller of claim 19 further configured to:
update the first configurable SOC threshold and the second configurable SOC threshold based on a trim parameter associated with the battery system.
